(19) United States
(12) Patent Application Publication
(10) Pub. No.: US 2015/0291845 A1
(43) Pub. Date: Oct. 15, 2015

(54) COMPOSITION FOR COATING LOW-REFRACTIVE LAYER, AND TRANSPARENT ELECTRICALLY-CONDUCTIVE FILM COMPRISING SAME

(71) Applicant: LG HAUSYS, LTD., Seoul (KR)

(72) Inventors: Hong Jin-Ki, Seoul (KR); Won-Kook Kim, Daejeon (KR)

(73) Assignee: LG HAUSYS, LTD., Seoul (KR)

(21) Appl. No.: 14/438,081

(22) PCT Filed: Sep. 30, 2013
(86) PCT No.: PCT/KR2013/008718

§ 371 Date: Apr. 23, 2015

(30) Foreign Application Priority Data
Nov. 7, 2012 (KR) 10-2012-0125460

(51) Int. Cl. C09D 183/06; C09D 5/24

(52) U.S. Cl. CPC C09D 183/06; C09D 5/24

(57) ABSTRACT

Provided is a composition for coating a low-refractive layer, the composition comprising a siloxane compound and a photo-acid generating agent. Also provided is a transparent electrically conductive film comprising a low-refractive layer which is formed by using the composition for coating the low-refractive layer.

### TECHNICAL FIELD

The present invention relates to a coating composition for a low refractive-index layer and a transparent conductive film including the same.

### BACKGROUND ART

Touch panels are classified into optical touch panels, surface acoustic wave touch panels, capacitive touch panels, resistive touch panels, and the like according to the method of detecting touch position. A resistive touch panel includes a transparent conductive film and a glass sheet having a transparent conductor layer attached thereto and placed opposite the transparent conductive film, with spacers interposed therebetween, wherein an electric current is passed to the transparent conductive film such that the voltage on the glass sheet having the transparent conductor layer attached thereto is measured. On the other hand, a capacitive touch panel is essentially composed of a substrate and a transparent conductive layer on the substrate, is characterized by absence of movable portions, and is applied to in-vehicle devices or the like by virtue of high durability and high transmittance thereof.

A transparent conductive film used in such a capacitive touch panel includes a conductive layer, wherein the conductive layer is subjected to patterning. Typically, while patterning includes coating photoresist onto the transparent conductive layer, and etching the conductive layer subsequent to developing, continuous studies on transparent conductive films capable of securing desired production rates and efficiency during patterning are being conducted.

### DISCLOSURE

### Technical Problem

It is one aspect of the present invention to provide a coating composition for a low refractive-index layer including a siloxane compound and a photoacid generator.

It is another aspect of the present invention to provide a transparent conductive film including a low refractive-index layer formed using the coating composition for a low refractive-index layer as set forth above.

### Technical Solution

In accordance with one aspect of the present invention, a coating composition for a low refractive-index layer includes a siloxane compound and a photoacid generator.

The siloxane compound may include a siloxane polymer represented by Formula 1:

(R₁)ₙ—Si—(O—R₂)₄₋ₙ

where R1 is a C₁ to C₁₈ alkyl group, a C₁ to C₁₈ vinyl group, a C₁ to C₁₈ allyl group, a C₁ to C₁₈ epoxy group, or a C₁ to C₁₈ acrylic group; R2 is a C₁ to C₆ alkyl group or a C₁ to C₆ acetoxy group; and n is an integer satisfying 0<n<4.

The siloxane polymer may have a molecular weight of about 500 to about 50,000.

The siloxane compound may be present in an amount of about 5% by weight (wt %) to about 100 wt % based on the total weight (100 wt %) of the coating composition.

The siloxane compound may be formed by sol-gel reaction.

The photoacid generator may be activated through UV irradiation at a wavelength of about 300 nm to about 400 nm.

The photoacid generator may include one generator selected from among an ionic photoacid generator, a non-ionic photoacid generator, and a polymeric photoacid generator.

The photoacid generator may be present in an amount of about 1 wt % to about 30 wt % based on the total weight (100 wt %) of the coating composition.

In accordance with another aspect of the present invention, a transparent conductive film includes a low refractive-index layer formed using the coating composition for a low refractive-index layer as set forth above.

The transparent conductive film may have a stack structure of a transparent substrate, a high refractive-index layer, the low refractive-index layer, and a conductive layer.

The low refractive-index layer may have an index of refraction of about 1.4 to about 1.5.

The low refractive-index layer may have a thickness of about 5 nm to about 100 nm.

The high refractive-index layer may have a thickness of about 20 nm to about 150 nm.

The transparent substrate may be a monolayer or multilayer film including any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethylmethacrylate (PMMA), ethylene vinyl alcohol (EVA), polyvinyl alcohol (PVA), and combinations thereof.

The conductive layer may include indium tin oxide (ITO) or fluorine-doped tin oxide (FTO).

The transparent conductive film may further include a hard coating layer on one or both surfaces of the transparent substrate.

### Advantageous Effects

The coating composition for a low refractive-index layer allows efficient improvement in transparent conductive layer patterning necessary for manufacture of capacitive transparent conductive films.

Such an improvement in transparent conductive layer patterning makes it possible to more efficiently produce transparent conductive films in a simple and timesaving manner.

### DESCRIPTION OF DRAWINGS

FIG. 1 is a schematic sectional view of a transparent conductive film according to one embodiment of the present invention.

FIG. 2 is a schematic sectional view of a transparent conductive film according to another embodiment of the present invention.

### BEST MODE

Hereinafter, embodiments of the present invention will be described in detail. However, it should be understood that the present invention is not limited to the following embodiments and should be defined only by the accompanying claims and equivalents thereof.

Portions irrelevant to the description will be omitted for clarity. Like components will be denoted by like reference numerals throughout the specification.

In the drawings, thicknesses of various layers and regions are enlarged for clarity, and thicknesses of some layers and regions are exaggerated for convenience.

It will be understood that when an element such as a layer, film, region or substrate is referred to as being placed “above (or below)” or “on (or under)” another element, it can be directly placed on the other element, or intervening layer(s) may also be present.

### Coating Composition for Low Refractive-Index Layer

In accordance with one embodiment of the present invention, a coating composition for a low refractive-index layer includes a siloxane compound and a photoacid generator.

When a capacitive transparent conductive film is applied to a touch panel, a conductive layer is subjected to patterning. Typically, in patterning of the transparent conductive layer, a method in which photoresist is coated onto the transparent conductive layer, followed by etching the transparent conductive layer subsequent to developing is mainly employed. However, this method has difficulty in efficiently manufacturing the patterned transparent conductive layer, since the method requires a large number of processes, which in turn causes reduction in production rate.

When a low refractive-index layer included in a transparent conductive film is prepared using a coating composition for a low refractive-index layer including a siloxane compound and a photoacid generator, the photoacid generator generates acids upon irradiation with UV light, and the acids act on a conductive layer deposited on the low refractive-index layer, whereby the conductive layer can be efficiently patterned during etching. Moreover, such an improvement in conductive layer patterning makes it possible to economically produce transparent conductive films in a relatively short time.

The siloxane compound may include a siloxane polymer represented by Formula 1:

(R₁)ₙ—Si—(O—R₂)₄₋ₙ

where R1 is a C₁ to C₁₈ alkyl group, a C₁ to C₁₈ vinyl group, a C₁ to C₁₈ allyl group, a C₁ to C₁₈ epoxy group, or a C₁ to C₁₈ acrylic group; R2 is a C₁ to C₆ alkyl group or a C₁ to C₆ acetoxy group; and n is an integer satisfying 0<n<4.

The siloxane polymer may have a molecular weight of about 500 to about 50,000. As used herein, the molecular weight refers to a weight average molecular weight, i.e. a weight fraction-weighted average of molecular weight values of a polymer compound having a molecular weight distribution. When the siloxane polymer, represented by Formula 1, has a molecular weight within this range, the coating composition can have good coatability during coating, and exhibit enhanced curing density during curing.

The siloxane compound refers to a siloxane polymer represented by Formula 1, wherein Formula 1 may be any one selected from the group consisting of tetraethoxysilane (Si(OC₂H₅)₄), tetramethoxysilane (Si(OCH₃)₄), triethoxy(ethyl) silane (C₂H₅Si(OC₂H₅)₃), trimethoxy(methyl)silane (CH₃Si(OCH₃)₃), triacetoxy(methyl)silane ((CH₃CO₂)₃SiCH₃), triacetoxy(vinyl)silane ((CH₃CO₂)₃SiCH═CH₂), tris(2-methoxyethoxy)(vinyl)silane ((CH₃OCH₂CH₂O)₃SiCH═CH₂), trimethoxy(octyl)silane (CH₃(CH₂)₇Si(OC₂H₅)₃), trimethoxy[2-(7-oxabicyclo[4.1.0]hept-3-yl)ethyl]silane (C₁₁H₂₂O₄Si), trimethoxy(propyl)silane (CH₃CH₂CH₂Si(OCH₃)₃), trimethoxy(oxyl)silane ((CH₃(CH₂)₇Si(OCH₃)₃), trimethoxy(octadecyl)silane (CH₃(CH₂)₁₇Si(OCH₃)₃), isobutyl(trimethoxy)silane ((CH₃)₂CHCH₂Si(OCH₃)₃), triethoxy(isobutyl)silane ((CH₃)₂CHCH₂Si(OC₂H₅)₃), trimethoxy(7-octen-1-yl)silane (H₂C═CH(CH₂)₆Si(OCH₃)₃), trimethoxy(2-phenylethyl)silane (C₆H₅CH₂CH₂Si(OCH₃)₃), dimethoxy-methyl(3,3,3-trifluoropropyl)silane (C₆H₁₃F₃O₂Si), dimethoxy(dimethyl)silane (C₂H₆Si(OC₂H₆)₂), triethoxy(1-phenylethenyl)silane ((C₂H₅O)₃SiC(CH₂)C₆H₅), triethoxy[4-(trifluoromethyl)phenyl]silane (CF₃C₆H₄Si(OC₂H₅)₂), triethoxy(4-methoxyphenyl)silane ((C₂H₅O)₃SiC₆H₄OCH₃), 3-(trimethoxysilyl)propyl methacrylate (H2C═C(CH₃)CO₂(CH₂)₃Si(OCH₃)₃), (3-glycidoxy)methyldiethoxysilane (C₁₁H₂₄O₄Si), 3-(triethoxysilyl)propylisocyanate ((C₂H₅O)₃Si(CH₂)₃NCO), isobutyltriethoxysilane ((CH₃)₂CHCH₂Si(OC₂H₅)₃), and combinations thereof.

Specifically, the siloxane compound is a compound including a siloxane polymer represented by Formula 1, and a general formula of the siloxane polymer is based on a siloxane bond of —Si—O—Si— and may be designated, for example, by Formula 2:

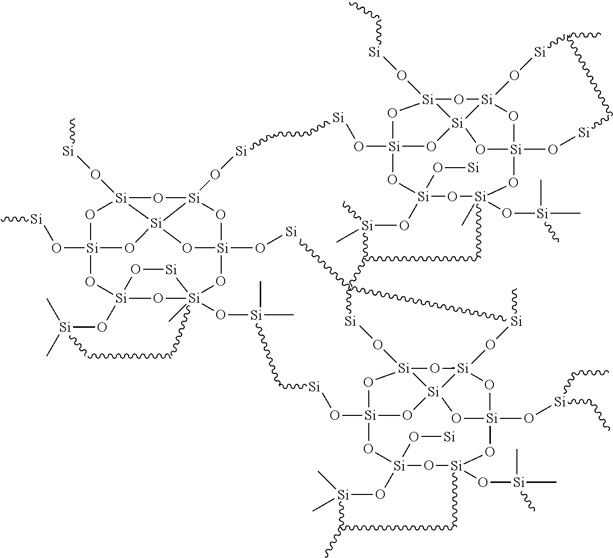

More specifically, the siloxane compound may be present in an amount of about 5 wt % to about 100 wt % based on 100 wt % of the composition. Within this range, the coating composition can reduce the index of refraction of a low refractive-index layer formed using the composition while enhancing curing reaction and improving solvent resistance and adherence.

The siloxane compound may be formed by any method known in the art without limitation. For example, the siloxane compound may be formed by a sol-gel reaction. As used herein, the sol-gel reaction refers to a reaction wherein, from a sol formed by dispersing silica nanoparticles into in a solution, a porous gel is formed through fluidity loss of the sol caused by agglomeration/coagulation of colloidal particles, wherein the silica nanoparticles are obtained by flame hydrolysis of a sol in which colloidal particles of dozens to several hundred nanometers obtained by hydrolysis or dehydration condensation polymerization are dispersed in a solution. As described above, the siloxane compound may be formed by sol-gel reaction. For example, a siloxane polymer represented by Formula 1 is mixed and reacted with water and ethanol to prepare a silica sol, followed by mixing a photoacid generator with the sol to convert the sol into liquid networks, thereby preparing a siloxane compound of inorganic networks.

As used herein, the photoacid generator (PAG) refers to a compound which generates acids by UV light irradiation. When a low refractive-index layer is formed using a coating composition for a low refractive-index layer including the photoacid generator, followed by irradiation of the low refractive-index layer with UV light, the photoacid generator generates acids which in turn act on a conductive layer deposited on the low refractive-index layer, thereby allowing efficient patterning of the conductive layer.

The photoacid generator may be activated through UV irradiation at a wavelength of about 300 nm to about 400 nm. Within this range, the photoacid generator decomposes to generate acids, whereby etching of the conductive layer, i.e. patterning of the conductive layer can be advantageously performed. In addition, within this range, there can be an advantage in terms of economic feasibility in that the most widely used generic UV irradiation apparatus can be employed.

The photoacid generator may be any one selected from among ionic photoacid generators, non-ionic photoacid generators, and polymeric photoacid generators. Examples of the ionic photoacid generators may include sulfonium salt compounds, iodonium salt compounds, and the like, and examples of the non-ionic photoacid generator may include nitrobenzylsulfonate compounds, azonaphthoquinone compounds, and the like, without being limited thereto.

Specifically, the photoacid generator may include at least one selected from the group consisting of Irgacure PAG 103, Irgacure PAG 121, CGI 725, CGI 1907, Irgacure 250, Irgacure PAG 290, GSID26-1, (all of which are made by BASF Co., Ltd), and combinations thereof.

More specifically, the photoacid generator may be present in amount of about 1 wt % to about 30 wt % based on 100 wt % of the composition. Within this range, patterning of the conductive layer can be easily performed, and deterioration in properties of a low refractive-index layer formed using the coating composition can be avoided, thereby providing a transparent conductive film that allows fine patterning with UV irradiation.

### Transparent Conductive Film

In accordance with another embodiment of the present invention, a transparent conductive film includes a low refractive-index layer formed using the coating composition for a low refractive-index layer including the siloxane compound and the photoacid generator.

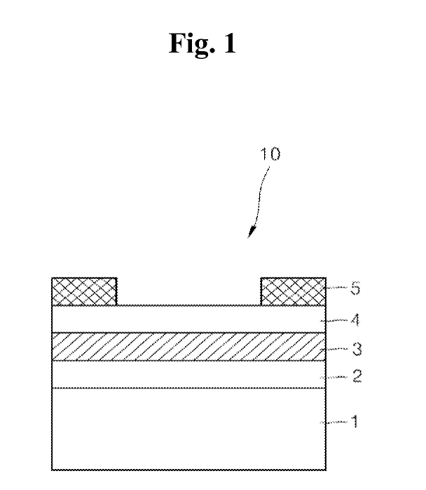

FIG. 1 is a schematic sectional view of a transparent conductive film according to one embodiment of the present invention. Referring to FIG. 1, the transparent conductive film 10 has a stack structure of a transparent substrate 1, a hard coating layer 2, a high refractive-index layer 3, a low refractive-index layer 4, and a conductive layer 5.

The transparent substrate 1 may include a film having good transparency and strength. Specifically, the transparent substrate 1 may be a monolayer or multilayer film including any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethyl methacrylate (PMMA), ethylene vinyl alcohol (EVA), polyvinyl alcohol (PVA), and combinations thereof.

The high refractive-index layer 3 and the low refractive-index layer 4 serve to improve insulation properties and light transmission between the transparent substrate 1 and the conductive layer 5, and the low refractive-index layer may be formed using the coating composition for a low refractive-index layer as set forth above.

The low refractive-index layer 4 may have an index of refraction of about 1.4 to about 1.5. Since the low refractive-index layer is formed using the coating composition for a low refractive-index layer including the siloxane compound and the photoacid generator, the index of refraction of the low refractive-index layer can be adjusted to about 1.4 to about 1.5, and the transparent conductive film can exhibit enhanced overall visibility and total luminous transmittance.

The low refractive-index layer 4 may have a thickness of about 5 nm to about 100 nm. Within this range, the low refractive-index layer can provide enhanced pattern visibility and transmittance to the transparent conductive film, and stress between the low refractive-index layer and the other layers including the high refractive-index layer can be maintained at a proper level, thereby securing adherence and reducing cracking and curling.

The high refractive-index layer 3 may have a thickness of about 20 nm to about 150 nm. Within this range, an insufficient improvement in transmittance and visibility caused by excessive reduction in thickness can be avoided, and cracking and curling due to stress can be reduced.

The conductive layer 5 is formed on the low refractive-index layer 4, and may include indium tin oxide (ITO) or fluorine-doped tin oxide (FTO). Specifically, the conductive layer 5 may have a thickness of about 5 nm to about 50 nm. Within this range, the conductive layer can have low sheet resistance while securing high transmittance and low reflectance.

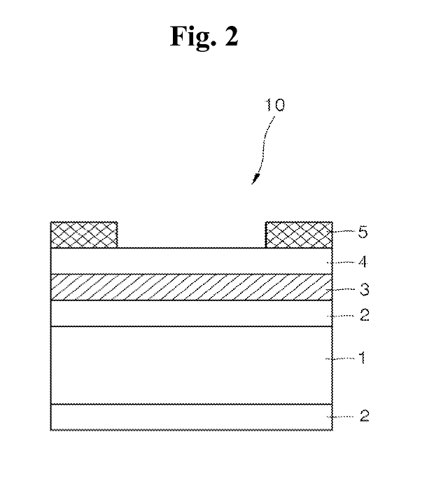

FIG. 2 is a schematic sectional view of a transparent conductive film according to another embodiment of the present invention, and a hard coating layer 2 is shown further formed under the transparent substrate 1. The hard coating layer 2 serves to enhance surface hardness and may be any compound typically used to form a hard coating layer, for example, acrylic compounds, without limitation.

While the hard coating layer 2 may only be formed on one surface of the transparent substrate 1, as shown in FIG. 1, it should be understood that the hard coating layer may be formed on both surfaces of the transparent substrate 1.

Hereinafter, the present invention will be described in more detail with reference to some examples. It should be understood that these examples are provided for illustration only and are not to be construed in any way as limiting the present invention.

### PREPARATIVE EXAMPLE

### Preparative Example 1

### Coating Composition for Low Refractive-Index Layer

Tetraethoxysilane (tetra-ethoxyorthosilicate, TEOS), water, and ethanol were mixed in a ratio of 1:2:2, followed by introducing 0.1 mol of a nitric acid solution and reacting for 24 hours, thereby preparing a silica sol having an index of refraction of 1.43. The prepared silica sol was measured as to solid content, followed by diluting with methylethylketone (MEK), thereby preparing a siloxane compound with a total solid content of 10%.

The prepared siloxane compound was mixed with a photoacid generator listed in Table 1, followed by diluting with methylethylketone (MEK), thereby preparing a coating composition for a low refractive-index layer with a total solid content of 5%.

TABLE 1

| | Composition | | |
|---|---|---|---|
| | Photoacid generator | | Siloxane |
| | Kind | Content | compound |
| Preparative Example 1-1 | Irgacure PAG 290 | 5 | 95 |
| Preparative Example 1-2 | GSID26-1 | 5 | 95 |
| Preparative Example 1-3 | Irgacure PAG 103 | 5 | 95 |
| Preparative Example 1-4 | Irgacure PAG 290 | 40 | 60 |
| Preparative Example 1-5 | Irgacure PAG 103 | 40 | 60 |
| Preparative Example 1-6 | — | 0 | 100 |

### Preparative Example 2

### Coating Composition for Hard Coating Layer

Based on 100 parts by weight of solids, 20 parts by weight of a dipentaerythritol hexaacrylate, 60 parts by weight of a UV-curable acrylate (HX-920UV, Kyoeisha Chemical Co., Ltd.), 15 parts by weight of silica nanoparticles (XBA-ST, Nissan Chemical Ind.), and 5 parts by weight of a photo-initiator (Irgacure-184, Ciba Specialty Chemicals) were mixed, followed by diluting with a diluting solvent methylethylketone (MEK), thereby preparing a coating composition for a hard coating layer with a solid content of 45% (index of refraction: 1.52).

### Preparative Example 3

### Coating Composition for High Refractive-Index Layer

Based on 100 parts by weight of solids, 36 parts by weight of a UV-curable acrylate (HX-920UV, Kyoeisha Chemical Co., Ltd.), 60 parts by weight of high refractive nanoparticles (ZrO₂ nanoparticles), and 4 parts by weight of a photo-initiator (Irgacure-184, BASF) were mixed, followed by diluting with a diluting solvent of methylethylketone (MEK), thereby preparing a coating composition for a high refractive-index layer with a solid content of 5% (index of refraction: 1.64).

### EXAMPLES AND COMPARATIVE EXAMPLE

### Example 1

The coating composition for a hard coating layer in Preparative Example 2 was coated onto a 125 μm thick PET film to a dried film thickness of 1.5 μm using a Meyer bar, followed by curing through UV irradiation at 300 mJ using an 180 W high voltage mercury lamp, thereby preparing a hard coating film. Next, the coating composition for a hard coating layer in Preparative Example 2 was coated onto the other surface of the film to a dried film thickness of 1.5 μm and then cured in the same manner, thereby preparing a film having a hard coating layer on both surfaces thereof.

Thereafter, the coating composition for a high refractive-index layer in Preparative Example 3 was coated onto one surface of the film with a hard coating layer on both surfaces thereof to a dried film thickness of 50 nm, followed by curing through UV irradiation at 300 mJ using an 180 W high voltage mercury lamp, thereby forming a high refractive-index layer.

Next, the coating composition for a low refractive-index layer in Preparative Example 1-1 was coated onto the high refractive-index layer to a dried film thickness of 20 nm, followed by curing in an oven at 150° C. for 1 minute, thereby forming a low refractive-index layer. Here, an ITO layer having a film thickness of 20 nm was formed on the low refractive-index layer using an ITO target with a ratio of indium to tin of 95:5, thereby preparing a transparent conductive film.

### Example 2

A transparent conductive film was prepared in the same manner as in Example 1 except that the coating composition for a low refractive-index layer in Preparative Example 1-2 was used, and the low refractive-index layer was formed to a thickness of 40 nm.

### Example 3

A transparent conductive film was prepared in the same manner as in Example 1 except that the coating composition for a low refractive-index layer in Preparative Example 1-3 was used, and the low refractive-index layer was formed to a thickness of 50 nm.

### Example 4

A transparent conductive film was prepared in the same manner as in Example 1 except that the coating composition for a low refractive-index layer in Preparative Example 1-4 was used, and the low refractive-index layer was formed to a thickness of 60 nm.

### Example 5

A transparent conductive film was prepared in the same manner as in Example 1 except that the coating composition for a low refractive-index layer in Preparative Example 1-5 was used, and the low refractive-index layer was formed to a thickness of 80 nm.

### Comparative Example

A transparent conductive film was prepared in the same manner as in Example 1 except that the coating composition for a low refractive-index layer in Preparative Example 1-6 was used, and the low refractive-index layer was formed to a thickness of 100 nm.

### EXPERIMENTAL EXAMPLE

### Physical Properties of Transparent Conductive Film

For each of the transparent conductive films prepared in Examples and Comparative Example, the following properties were measured. Results are shown in Table 2.

1) Patterning evaluation of transparent conductive film: a photo-mask of a Cr-deposited glass sheet having a pattern of 50 mm×50 mm squares drawn thereon was placed 100 μm from each of the transparent conductive films in Examples and Comparative Example, followed by irradiation with UV energy at 1,000 J/cm² using a high voltage mercury lamp having a wavelength of 365 nm. Next, the photo-mask was removed, followed by washing the conductive layer of the transparent conductive film with distilled water, thereby obtaining a patterned transparent conductive film. Patterned square portions were observed with the naked eye to determine whether patterning was accomplished, followed by measuring the surface resistance of the patterned portions.

2) Pencil hardness: Pencil hardness was measured in accordance with JIS K 5600-5-4.

3) Adherence: A surface of the transparent conductive film was cut into a lattice of 10 mm×10 mm (length×width) squares at intervals of 1 mm using a cutter, followed by conducting a peel test using a cellophane adhesive tape (Nichiban Co., Ltd). The peel test was repeated three times for the same portion using the tape. The number of unpeeled square portions was identified and indicated based on 100 portions (n/100).

TABLE 2

| | | | | | | Comparative |
|---|---|---|---|---|---|---|
| | Example 1 | Example 2 | Example 3 | Example 4 | Example 5 | Example 1 |
| Patterning | ⊚ | ⊚ | ⊚ | Δ | Δ | X |
| properties | | | | | | |
| Surface | 145 | 150 | 152 | 147 | 158 | 151 |
| resistance of | | | | | | |
| unpatterned | | | | | | |
| portion | | | | | | |
| Surface | No | No | No | No | No | 149 |
| resistance of | measurement | measurement | measurement | measurement | measurement | |
| patterned | | | | | | |
| portion | | | | | | |
| Pencil | 1H | 1H | 1H | F | F | 1H |
| hardness | | | | | | |
| Adherence | 100/100 | 100/100 | 100/100 | 0/100 | 0/100 | 100/100 |

⊚: excellent,
◯: good,
Δ: normal,
X: poor

It could be confirmed from the results in Table 2 that the transparent conductive films of Examples 1 to 5 had hardness and adherence above a certain level, and exhibited above-normal patterning properties. Specifically, it was ascertained that, in Examples 1 to 3 which included the low refractive-index layer formed using the coating composition for a low refractive-index layer including a predetermined amount of the photoacid generator, patterning with UV irradiation was accomplished, in view of the fact that square patterns were weakly visible, and that, for unpatterned portions, the measured surface resistance was about 150 Ω/sq, whereas, for patterned portions, no measurements were obtained upon measurement of surface resistance.

Specifically, it was ascertained that Examples 4 to 5 in which the coating composition for a low refractive-index layer included an excess of the photoacid generator as compared with Examples 1 to 3 were confirmed to exhibit generally normal patterning properties, although there was a difficulty in identifying whether patterning was accomplished because the conductive layer was peeled off due to instability of the low refractive-index layer. On the contrary, it could be seen that, in Comparative Example which included the low refractive-index layer formed using the coating composition for a low refractive-index layer not including the photoacid generator, patterning with UV irradiation was not accomplished, in view of the fact that the transparent conductive film exhibited substantially the same resistance of about 150 Ω/sq over the entire surface thereof.

1. A coating composition for a low refractive-index layer, comprising: a siloxane compound; and a photoacid generator.

2. The coating composition according to claim 1, wherein the siloxane compound comprises a siloxane polymer represented by Formula 1:
(R₁)ₙ—Si—(O—R₂)₄₋ₙ
where R1 is a C₁ to C₁₈ alkyl group, a C₁ to C₁₈ vinyl group, a C₁ to C₁₈ allyl group, a C₁ to C₁₈ epoxy group, or a C₁ to C₁₈ acrylic group; R2 is a C₁ to C₆ alkyl group or a C₁ to C₆ acetoxy group; and n is an integer satisfying 0<n<4.

3. The coating composition according to claim 2, wherein the siloxane polymer has a molecular weight of 500 to 50,000.

4. The coating composition according to claim 1, wherein the siloxane compound is present in an amount of 5 wt % to 100 wt % based on the total weight (100 wt %) of the coating composition.

5. The coating composition according to claim 1, wherein the siloxane compound is formed by sol-gel reaction.

6. The coating composition according to claim 1, wherein the photoacid generator is activated through UV irradiation at a wavelength of 300 nm to 400 nm.

7. The coating composition according to claim 1, wherein the photoacid generator comprises one generator selected from among an ionic photoacid generator, a non-ionic photoacid generator, and a polymeric photoacid generator.

8. The coating composition according to claim 1, wherein the photoacid generator is present in an amount of 1 wt % to 30 wt % based on the total weight (100 wt %) of the coating composition.

9. A transparent conductive film comprising: a low refractive-index layer formed using the coating composition for a low refractive-index layer according to claim 1.

10. The transparent conductive film according to claim 9, wherein the transparent conductive film has a stack structure of a transparent substrate, the high refractive-index layer, a low refractive-index layer, and a conductive layer.

11. The transparent conductive film according to claim 9, wherein the low refractive-index layer has an index of refraction of 1.4 to 1.5.

12. The transparent conductive film according to claim 9, wherein the low refractive-index layer has a thickness of 5 nm to 100 nm.

13. The transparent conductive film according to claim 10, wherein the high refractive-index layer has a thickness of 20 nm to 150 nm.

14. The transparent conductive film according to claim 10, wherein the transparent substrate is a monolayer or multilayer film comprising any one selected from the group consisting of polyethylene terephthalate (PET), polyethylene naphthalate (PEN), polyethersulfone (PES), polycarbonate (PC), polypropylene (PP), polyvinyl chloride (PVC), polyethylene (PE), polymethylmethacrylate (PMMA), ethylene vinyl alcohol (EVA), polyvinyl alcohol (PVA), and combinations thereof.

15. The transparent conductive film according to claim 10, wherein the conductive layer comprises indium tin oxide (ITO) or fluorine-doped tin oxide (FTO).

16. The transparent conductive film according to claim 10, further comprising: a hard coating layer on one or both surfaces of the transparent substrate.
